(19) United States
(12) Patent Application Publication
(10) Pub. No.: US 2006/0054659 A1
(43) Pub. Date: Mar. 16, 2006

(54) Method and apparatus for blending a colorant

(76) Inventor: Philip T. Radford, Roebuck, SC (US)

Correspondence Address: John E. Vick, Jr., Legal Department, M-495, PO Box 1926, Spartanburg, SC, 29304, US

(21) Appl. No.: 10/942,447

(22) Filed: Sep. 16, 2004

(51) Int. Cl. A47J 36/02

(52) U.S. Cl. 228/101

(57) ABSTRACT

The disclosure is directed to a method and apparatus for homogenously mixing of colorant easily and reliably into a polyol, aqueous solution, or polymer. In the practice of the invention, almost any colorant or dye can be employed. One use of the invention employs polymeric colorant. The colorant is deployed in-line to a polymer as the polymer is pumped along a conduit. The polymer may be stored in the colored state, or stored uncolored. Use of the invention may avoid the undesirable and costly procedure of applying colorant directly into blending vessels. Thus, in the practice of the invention, blending vessels may remain uncolored, which is advantageous.

### BACKGROUND OF THE INVENTION

Colorants, also known as “coloring agents”, are used to impart color to thermoplastics and thermosets, as well as aqueous based systems. There are several methods of applying colorant into a chemical system. For example, as shown in FIG. 1, a colorant may be provided in a batch process to a blending vessel to afford color in the formation of finished parts or solutions. In the blender vessel of FIG. 1, a polyol (also referred to herein as a “polymer” or “resin”), surfactants, catalysts, and blowing agents are mixed. Colorant may be added to a blender vessel in conventional processes.

In FIG. 1, colorant is added to a blending vessel 21, which contains a mechanical mixing mechanism 22 that serves to blend the reactant mixture 25. A pump 23 transfers the reaction mixture 25 along first conduit 24 to a colored product storage container 26. Then, liquid is provided along second conduit 28 to output lines 29-31. Output line 29 provides the colored product into tanker truck 32. Output line 30 provides the colored product into containers 34a-c. Output line 31 provides colored liquid product to container packages 36a-d.

There are several disadvantages of prior art systems that require deposit of colorant into a blending vessel. For example, product having only a single color may be used in a given blending vessel at one time. Furthermore, the blending vessel must be completely and thoroughly cleaned prior to the use of that blending vessel for another color, to avoid undesirable mixing or dilution of color. There are many surfaces within a blending vessel and its associated conduits that must be completely washed and cleaned before a color change can be made properly. This is very difficult to accomplish. Small traces of color may contaminate subsequent batches. In addition, the water that is used to clean the tank must be purified and cleaned before it is released to the environment. Waste water treatment plants are a significant source of capital cost and ongoing expense. Changing color in such apparatus is costly, time consuming and difficult.

In conventional operations that require multiple colors, multiple large blending vessels commonly are used (i.e. one for each color), thus increasing the amount of capital equipment that must be employed in a process.

In general, mechanical mixing means are needed to thoroughly and properly mix colorant with a liquid polymer that is located at rest in a blending vessel. Mechanical mixing equipment is relatively expensive, and must be maintained mechanically. Furthermore, such mixing requires the expenditure of a large amount of energy, which is costly.

U.S. Pat. No. 6,247,839 is directed to an apparatus that is capable of dosing color into a manifold for use in subsequent processing.

A method that facilitates the application of color in a homogenous manner into a resin or polymer without the necessity to employ such mechanical mixing means would be very desirable.

### BRIEF DESCRIPTION OF THE DRAWINGS

A full and enabling disclosure of this invention, including the best mode shown to one of ordinary skill in the art, is set forth in this specification. The following Figures illustrate the invention:

FIG. 2 shows one application of the invention that involves the application of a single color injection of colorant in-line;

FIG. 3 schematically shows one example of a multiple color injection in-line in which at least two colorants are applied at different points into a conduit;

FIG. 4 shows one process in which colorant is injected as the polymer is loaded into containers;

FIG. 5 illustrates yet another embodiment of the invention in which color is applied to a resin system; then the polymer product is stored for a period of time, followed by packaging of the polymer product for transport;

FIG. 6 shows one feature providing for the storage of an uncolored liquid product, including subsequent application of colorant in-line during the transfer of the liquid into containers for transport;

FIG. 7 shows schematically how one might apply a different colorant to different output lines.

### DETAILED DESCRIPTION OF THE INVENTION

Reference now will be made to the embodiments of the invention, one or more examples of which are set forth below. Each example is provided by way of explanation of the invention, not as a limitation of the invention. In fact, it will be apparent to those skilled in the art that various modifications and variations can be made in this invention without departing from the scope or spirit of the invention.

The invention is directed to a method and apparatus for providing for the homogenous mixing of colorant easily and reliably into a liquid. Any liquid, polymer, or polymeric precursor, or multi-component system could be used, including for example polyurethane. In the practice of the invention, almost any colorant or dye can be employed. One use of the invention employs polymeric colorant. However, the invention also could have applicability to dyes, or pigments.

One class of colorant that could be effectively used in the practice of the invention is the Reactint® polymeric colorant product line marketed and sold by Milliken & Company of Spartanburg, S.C. Virtually any color scheme could be employed, including for example orange, red, black, violet, blue, yellow, or combinations of the above. Colorants of this type are disclosed in U.S. Pat. Nos. 5,290,921 and 5,925,150; as examples. The invention is not limited to the use of any particular type of colorant, but those described herein are provided as examples for the practice of the invention.

The colorant may be injected in-line, using essentially any apparatus capable of applying a colorant into a conduit having a stream of polyol or fluid within the conduit. It has been found, however, that certain apparatus is particularly useful in the practice of the invention. For example, one apparatus that has been found to work well in the practice of the invention is an injection apparatus similar to that shown in U.S. Pat. No. 6,247,839 to Kochanowicz et al. An apparatus similar to that shown in this patent, which is commercially available in the industry, can be used. One device that may be used is a Millijector™ dosing unit that is distributed for commercial use by Milliken & Company of Spartanburg, S.C.

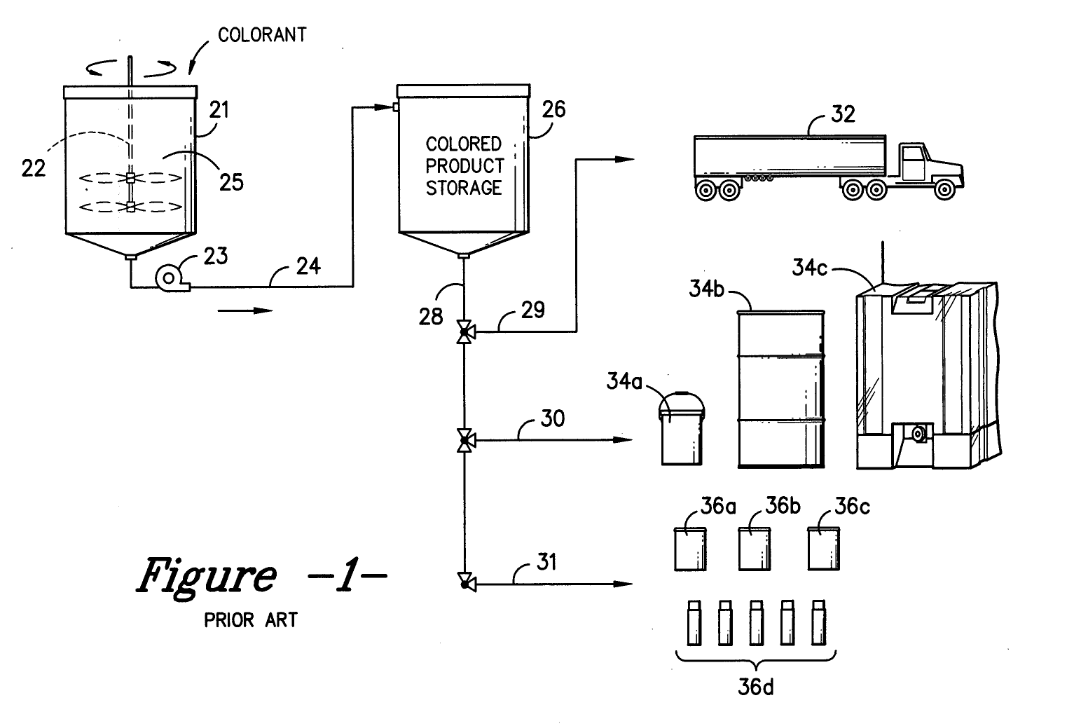

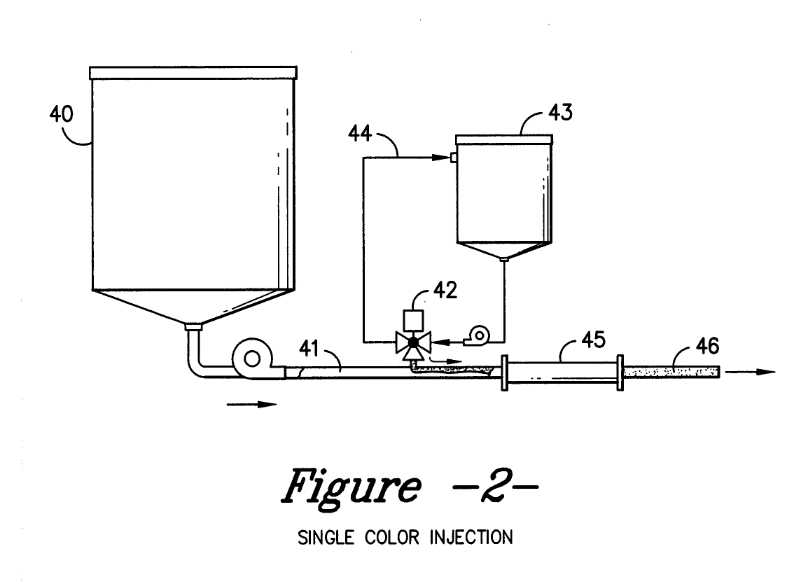

In FIG. 2, a blending vessel 40 supplies liquid along conduit 41. Conduit 41, in this example, feeds an uncolored liquid. Injector 42 applies colorant from vessel 43, which contains colorant. A recirculation loop 44 is show as well, which serves to recirculate the colorant. Once the colorant is added to conduit 41, the colorant is mixed with the fluid as they pass together through static mixer 45. In general, some level of shear is required to homogenously mix the colorant into the fluid. Another form of mixing may occur when the stream containing color impinges upon a surface of body of quiescent fluid. The static mixer 45 is optional, but is shown in the particular embodiment of FIG. 2. Conduit 46 is shown as well, which contains colored liquid product that has emerged from the static mixer 45. The location of the pump that moves the liquid may be located upstream or downstream of the liquid injection. For purposes of clarity the pump is denoted as being upstream of the color introduction in the Figures. A gear pump also could be used to mix the colorant into the fluid. The process shown in FIG. 2 represents a single color injection process of the invention.

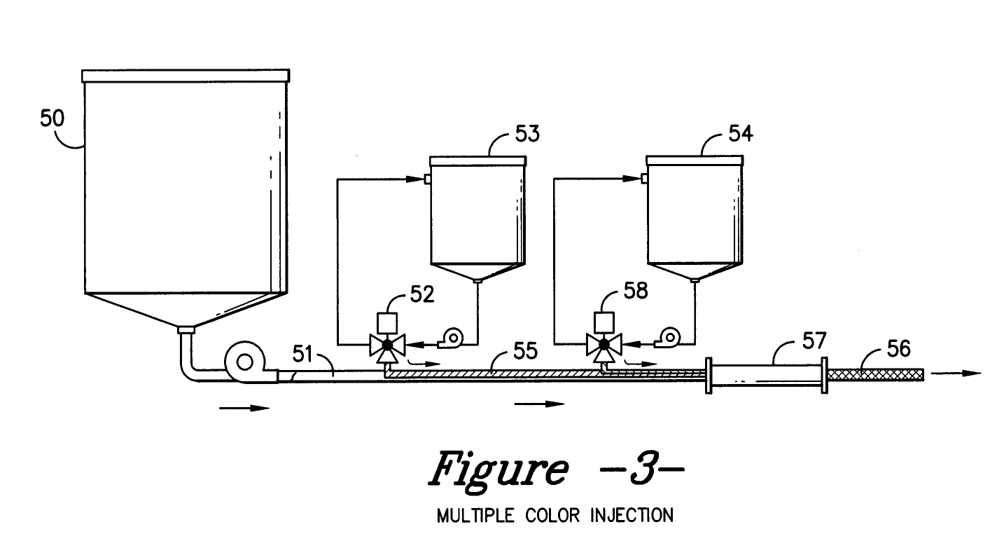

FIG. 3 shows a multiple color injection process according to the invention. Blending vessel 50 provides blended, uncolored liquid along conduit 51. First injector 52 provides a first colorant into the conduit 51 from the first colorant vessel 53. A second injector 58 provides colorant from second colorant vessel 54 into conduit 51. One can see within conduit 51 the partially colored liquid 55 that has received only one color, and the fully colored liquid 56 (both colors applied) that emerges beyond the optional static mixer 57.

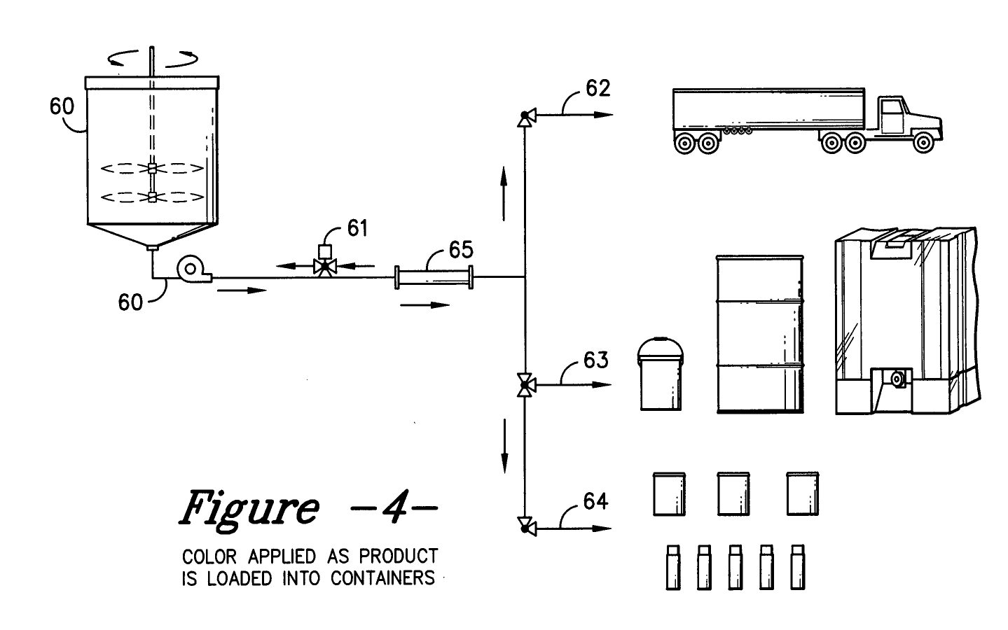

In one aspect of the invention, colorant may be applied as a product is loaded into containers. Thus, one aspect of the invention would involve the direct application of colorant in-line between a blending vessel 60 (FIG. 4) and various containers. In FIG. 4, blending vessel 60 provides uncolored liquid along conduit 60. The injector 61 injects colorant as previously described into the conduit 60, and an optional static mixer insures a homogenous mixing of the colorant into the liquid. A first output line 62 provides colored product to a tanker truck, a second output line 63 provides colored product to mid-sized containers such as pails, drums or tote bins. A third output line 64 provides colored product to smaller containers such as buckets, bottles, or aerosol cans.

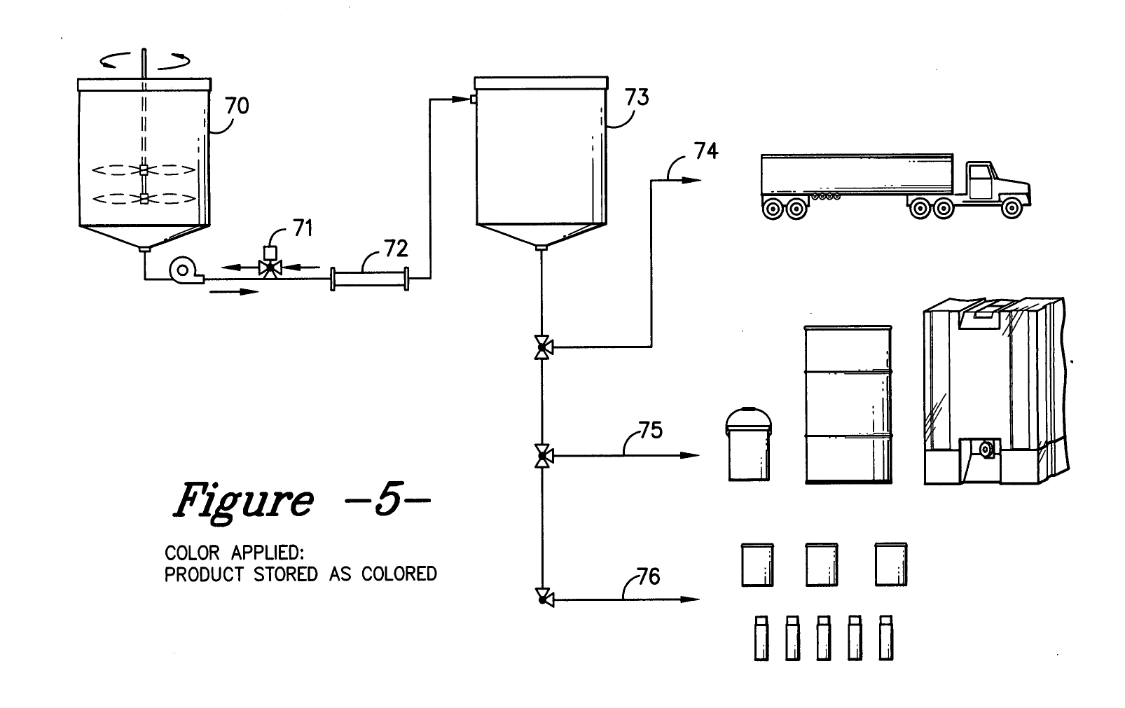

In yet another embodiment of the invention, a colorant may be applied to a liquid or fluid product by injection, and then the liquid product may be stored in its colored state. Then, when needed, the colored product can be dispatched into containers for transport. In FIG. 5, a blending vessel 70 provides uncolored liquid along a conduit to a point at which injector 71 provides colorant into a conduit. Then, the liquid and colorant are mixed within static mixer 72 and supplied to storage vessel 73. The colored liquid product then is stored until needed. Then, when needed, the liquid product may be dispatched from the storage vessel 73 along output lines 74-76 as shown in FIG. 5.

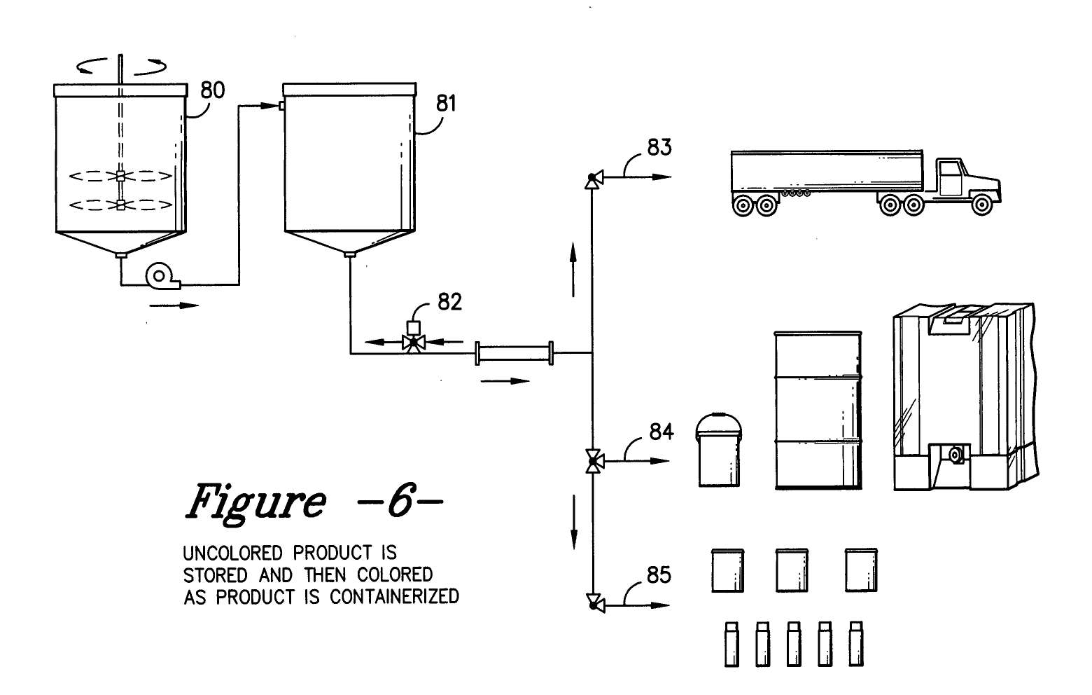

In yet another aspect of the invention, an uncolored liquid product may be stored, and then colored after the product is removed from the storage vessel and is in the process of being dispatched into containers for transport. FIG. 6 shows a blending vessel 80, which provides uncolored product to a storage vessel 81. The uncolored liquid product is stored for a period of time. Then, when needed, the uncolored product receives a colorant from injector 82 as it proceeds along to the output lines 83-85.

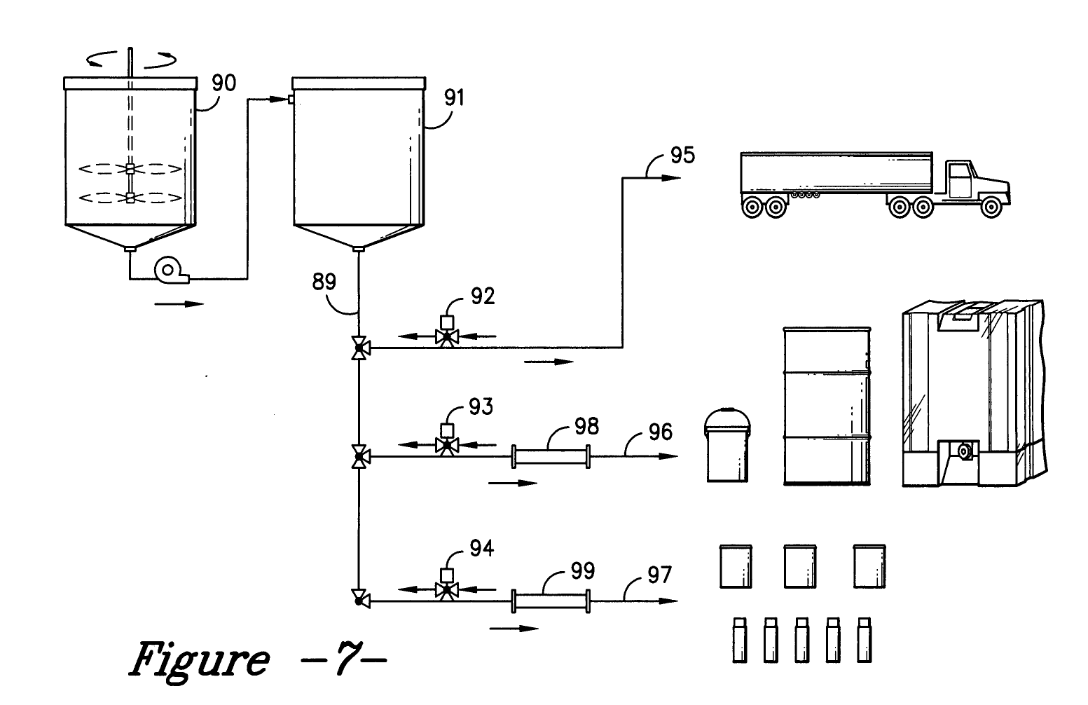

FIG. 7 shows yet another aspect of the invention in which different colorants of different color shade can be simultaneously applied to a multiple streams after the storage. In FIG. 7, a blending vessel 90 applies uncolored liquid to a storage vessel 91. When needed, the uncolored liquid is supplied from storage vessel 91 along conduit 89, and then can be split two, three, or more ways. The first injector 92, the second injector 93, and the third inject 94 apply in parallel three different colors to the respective lines. Thus a product having a first color is produced from output line 95, a liquid product having a second color (different) is produced from output line 96, and a product having a third color (different) is produced along output line 97. FIG. 7 shows that the static mixer 98 and static mixer 99 are optional, and are not necessary required in the practice of the invention. Each particular color and each particular liquid that is employed in the invention will have different requirements as to what is needed in order to make mixing occur. Thus, a static mixer may not be required, depending upon the application, the length of conduit, the level of turbulence, and the difficulty of solubilizing the colorant into the liquid.

With regard to the mixing of colorant into liquid or polyol solutions, it should be recognized that the invention advantageously does not require mechanical mechanisms or paddle means to mix the colorant into the liquid. One significant advantage of the invention is that mixing may occur by using a non-energized source of mixing, such as a static mixer, or in other applications, simply by relying on the aggressive flow (may be laminar or turbulent) of the liquid along the conduit or turbulence encountered during discharge to mix the colorant into the liquid. It is one advantage of the invention that mechanical paddles and stirring apparatus are not required to provide the colorant into the liquid, which may save on energy costs and maintenance required to operate and maintain such equipment.

The application of the invention results in a given amount of equipment being capable of supplying a much larger number of differently colored products as output. Thus, in the practice of the invention, it is possible in some cases to avoid multiple redundant mixing or blending vessels. Furthermore, the need to clean all the conduits and lines associated with the mixing and blending apparatus in order to effect a color change is avoided in the practice of the invention. This can be optimized with a minimal purge of uncolored material to clean the lines for subsequent colors.

### Example 1

In this example, the resin or polyol (liquid) is blended, and then colored using the in-line coloring system previously shown in connection with FIG. 4. Then, the colored liquid is applied into containers. A Viking brand SG570 gear pump was used for the polyol side, and a Viking SG417 pump was used for the color addition. The polyol flow rate was 1000 grams/minute, which corresponds to about 136 rpm of the particular gear pump. The color flow rate employed was about 2.5 grams per minute (g/m) (15 rpm), which resulted in about 0.25 pphp (parts per hundred of polyol). Furthermore, a second color flow rate used was about 10.0 grams per minute (g/m) (60 rpm), which resulted in about 1.0 pphp of polyol. Thus, two different color loadings were used. For the experiment, a low flow Millijector™ dosing unit was used to accurately dispense the color, which provided rapid color startup and shutoff. The static mixer was used to provide adequate color and polyol mixing. To drive the whole system a Full-flux AC Vector motor and drive was used to provide consistent motor pump speed.

The resin was colored and then combined with isocyanate used to manufacture a urethane system part. The parts made as described were then compared visually to a part that was employed as a laboratory standard. There was an exact visual match between the parts that were manufactured with a weighing of the lab standard, versus ones that were dosed volumetrically using this system. With the system, a rapid color start-up was observed having about a five second delay. Shut-off lasted about seven seconds when there was no color dosed to the resin system. Unexpectedly superior and surprising results were obtained using the process of the invention.

### Example 2

In a second example, colorant was applied to a resin or polyol stream in-line and then the colored resin was stored for a period of time. See FIG. 5, as example, and the discussion accompanying FIG. 5. The colored resin was then pumped from a storage tank into containers.

Referring to FIG. 5, a 55-gallon drum and the 3-way valve that is provided directly into a 3-inch line A desired flow rate is employed that is about 50-100 gallons per minute of resin. The percentage of color dosed was about 0.23 parts per hundred polyol. To perform this experiment a Viking Spur gear pump was used to control color introduction. The polyol pump was a double diaphragm pump.

### Example 3

A resin was blended, and then pumped to a storage tank in an uncolored state, as shown in FIGS. 6-7. After the resin is stored for a period of time, the resin is pumped in the uncolored state from the storage tank. The color may be injected in-line, and then the colored resin may be applied to containers.

It is understood by one of ordinary skill in the art that the present discussion is a description of exemplary embodiments only, and is not intended as limiting the broader aspects of the present invention, which broader aspects are embodied in the exemplary constructions. The invention is shown by example in the appended claims.

1. A method of coloring an uncolored fluid as said uncolored fluid travels within or exists from a conduit, said method comprising:
(a) pumping said uncolored fluid through a conduit;
(b) injecting a first colorant into said conduit;
(c) mixing said first colorant with said uncolored fluid as said uncolored fluid travels within or exits said conduit; and
(d) thereby coloring said uncolored fluid to form a colored fluid.

2. The method of claim 1 wherein said fluid comprises a polymer precursor.

3. The method of claim 1 further comprising the following step:
(e) depositing said “colored fluid” into a storage vessel.

4. The method of claim 3 further comprising:
(f) moving said colored fluid from said storage vessel to a container for transport.

5. The method of claim 2 wherein said polymer precursor comprises a polyol.

6. The method of claim 5 wherein said first colorant comprises a polymeric colorant.

7. The method of claim 1 wherein said mixing step (c) is accomplished using a static mixer.

8. The method of claim 7 wherein said static mixer is non-energized, such that mixing of said fluid with said colorant is powered solely by the movement of said fluid within said static mixer.

9. The method of claim 1, comprising the following additional steps:
(e) injecting a second colorant into said conduit;
(f) homogeneously mixing said second colorant with said fluid as said fluid travels within said conduit; and
(g) thereby forming a colored fluid that is colored by more than one colorant species.

10. The method of claim 9 wherein said fluid comprises a liquid polymer component.

11. The method of claim 9 further comprising the following step:
(h) depositing said colored fluid into a storage vessel.

12. The method of claim 11 further comprising:
(i) moving said colored fluid from said storage vessel to a container for transport.

13. The method of claim 10 wherein said polymer comprises a polyurethane.

14. The method of claim 13 wherein said first and said second colorants each comprise polymeric colorants.

15. The method of claim 9 wherein said mixing step (f) is accomplished using a static mixer.

16. The method of claim 15 wherein said static mixer is non-energized, such that mixing of said fluid with said colorant is powered solely by the movement of said fluid within said static mixer.

17. A method of applying colorant to a polymer, said method comprising:
(a) blending a polymer in a blending vessel,
(b) transporting said blended polymer to a storage vessel,
(c) storing said polymer for a period of time,
(d) pumping said polymer through a conduit, said polymer exhibiting turbulent flow within or upon discharge from said conduit;
(e) injecting a first colorant into said conduit;
(f) homogeneously mixing said colorant with said polymer as said polymer travels within said conduit; and
(g) thereby forming a colored polymer.

18. The method of claim 17 wherein said conduit is split into multiple lines, wherein different colorants having different colors may be injected into each of said respective multiple lines, thereby facilitating the production of multiple colored polymers.
